(19) United States
(12) Patent Application Publication
(10) Pub. No.: US 2017/0163563 A1
(43) Pub. Date: Jun. 8, 2017

(54) MULTIPLEXING NETWORK CONNECTIONS

(71) Applicant: HEWLETT PACKARD ENTERPRISE DEVELOPMENT LP, Houston, TX (US)

(72) Inventors: Linghan Cai, Fremont, CA (US); Robert Neal-Joslin, Fremont, CA (US)

(73) Assignee: HEWLETT PACKARD ENTERPRISE DEVELOPMENT LP, Houston, CA (US)

(21) Appl. No.: 15/327,455

(22) PCT Filed: Aug. 29, 2014
(86) PCT No.: PCT/US2014/053453

§ 371 Date: Jan. 19, 2017

(51) Int. Cl. H04L 12/911; H04L 12/26; H04L 29/06; H04W 8/18

(52) U.S. Cl. CPC H04L 47/821; H04W 8/186; H04L 43/16; H04L 63/104; H04L 63/08

(57) ABSTRACT

Example embodiments relate to multiplexing network connections. In this manner, the embodiments disclosed herein enable receipt of a request from a user to access a computing device. A first user group associated with the first user may be identified. A determination may be made as to whether the first user group has control over any network connections of a set of network connections available from the computing device. Responsive to the first user group not having control over any network connections available from the computing device, the request may be included in a priority queue for requests. Responsive to a network connection becoming available, a request from the priority queue may be selected and control of the network connection may be made available to user group associated with the user from which the request was received.

### BACKGROUND

The ability of a computing device to access a server may be limited based on the number of network connections available on the server via which the server and the computing device may communicate. This issue may be exacerbated when multiple entities, each with multiple users, attempt to access a set of server resources with a limited number of network connections.

### BRIEF DESCRIPTION OF THE DRAWINGS

The following detailed description references the drawings, wherein:

FIG. 1 is a block diagram of an example computing device for multiplexing network connections;

FIG. 2 is a block diagram of an example computing device for multiplexing network connections;

FIG. 3 is a block diagram of an example computing device for multiplexing network connections in communication with a plurality of computing devices;

FIG. 4 is a flowchart of an example method for execution by a computing device for multiplexing network connections; and

FIG. 4A is a flowchart of an example method for execution by a computing device for multiplexing network connections.

### DETAILED DESCRIPTION

The following detailed description refers to the accompanying drawings. Wherever possible, the same reference numbers are used in the drawings and the following description to refer to the same or similar parts. While several examples are described in this document, modifications, adaptations, and other implementations are possible. Accordingly, the following detailed description does not limit the disclosed examples. Instead, the proper scope of the disclosed examples may be defined by the appended claims.

A system may comprise a computing device capable of communicating with numerous user groups over the Internet. A user group may comprise an entity, organization, company, external system, and/or other conglomeration of individuals. Each user group may comprise a set of users, whereby each user may communicate with the computing device via a respective user computing device.

The computing device (and/or the system) may provide services, information, management functionality, and/or other resources to a user device via connections established by an associated user group. In some examples, the number of user devices (and/or user groups) may exceed the number of network connections to the computing device. In some examples, authentication is required before an individual user device may access the computing device via a network connection. In some examples, the communication (and/or transactions) between a user device and the computing device over the network connection may be discrete and/or quick.

As such, communication between the user devices (and user groups) and the computing device in the system may involve lengthy initial communications between the computing device. In particular, the determinations of which device may use which network connection may be time-consuming and involve complex processing and management.

Examples disclosed herein address this issue by multiplexing network connections so as to allocate the network connections among user groups. The computing device may facilitate use of a network connection by numerous user groups (and user computing devices). To that end, the computing device may determine whether a user providing an incoming request is associated with a user group that controls any of the set of network connections of the computing device. Based on whether the user group of the user controls a network connection, the computing device may place the provided request in a queue of requests from users associated with user groups that do not control any network connections. Responsive to a network connection becoming available, requests from the queue may be selected to be performed on the available network connection. Access to a network connection may be multiplexed and granted based on a priority associated with the user group, by selecting a request from the queue based on a priority associated with a corresponding user group.

As such, examples described herein receive a request from a user to access the computing device, identify a user group with which the user is associated, and determine whether the user group has control over any network connections of the computing device. Responsive to the user group not having control over any network connections, the request may be included in a priority queue for requests. Responsive to a network connection becoming available, a request may be selected from the priority queue and control of the available network connection may be made available to the user group associated with the user from whom the request was received.

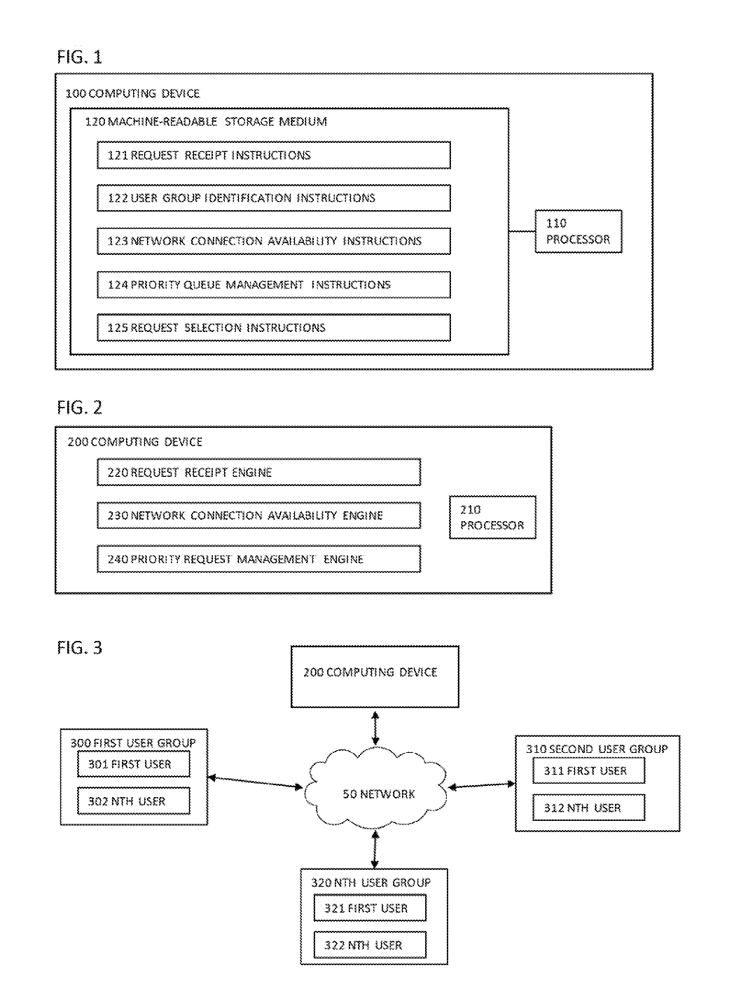

Referring now to the drawings, FIG. 1 is a block diagram of an example computing device 100 for multiplexing network connections. Computing device 100 may be a cloud server, a mainframe, notebook, desktop, tablet, workstation, mobile device, or any other device suitable for executing the functionality described below. In some examples, computing device 100 may be part of a system of computing devices, such that each computing device in the system may comprise the functionality and/or structure of computing device 100. In some examples, the computing device 100 (and/or other computing devices in the system of computing devices) may be management servers that provide services, functionality, information, and/or other data to user groups. In the embodiment of FIG. 1, computing device 100 includes a non-transitory machine-readable storage medium 120 and a processor 110.

Processor 110 may be one or more central processing units (CPUs), microprocessors, and/or other hardware devices suitable for retrieval and execution of instructions stored in machine-readable storage medium 120. Processor 110 may fetch, decode, and execute program instructions 121, 122, 123, 124, 125, and/or other instructions to enable multiplexing network connections, as described below. As an alternative or in addition to retrieving and executing instructions, processor 110 may include one or more electronic circuits comprising a number of electronic components for performing the functionality of one or more of instructions 121, 122, 123, 124, 125, and/or other instructions.

In one example, the program instructions 121, 122, 123, 124, 125, and/or other instructions can be part of an installation package that can be executed by processor 110 to implement the functionality described herein. In this case, memory 120 may be a portable medium such as a CD, DVD, or flash drive or a memory maintained by a computing device from which the installation package can be downloaded and installed. In another example, the program instructions may be part of an application or applications already installed on computing device 100.

Machine-readable storage medium 120 may be any hardware storage device for maintaining data accessible to computing device 100. For example, machine-readable storage medium 120 may include one or more hard disk drives, solid state drives, tape drives, and/or any other storage devices. The storage devices may be located in computing device 100 and/or in another device in communication with computing device 100. For example, machine-readable storage medium 120 may be any electronic, magnetic, optical, or other physical storage device that stores executable instructions. Thus, machine-readable storage medium 120 may be, for example, Random Access Memory (RAM), an Electrically-Erasable Programmable Read-Only Memory (EEPROM), a storage drive, an optical disc, and the like. As described in detail below, machine-readable storage medium 120 may be encoded with executable instructions for multiplexing network connections. As detailed below, storage medium 120 may maintain and/or store th e data and information described herein.

Request receipt instructions 121, when executed by processor 110, may receive a request from a user to access the computing device 100. The request receipt instructions 121, when executed by processor 110, may receive the request from a user associated with a user group. The user may communicate with the computing device 100 via a user computing device (as described below in FIG. 3). As such, functionality and description pertaining to a user's actions may be implemented by an associated user computing device.

User group identification instructions 122, when executed by processor 110, may identify a user group with which the user is associated. For example, the user group identification instructions 122, when executed by processor 110, may identify a user group with which the user is associated based on a certificate, signing of a CA certificate, and/or other credential associated with the user and the user group, based on metadata associated with the user and/or the user group, based on information related to the user group regarding a list of users, and/or based on other information that may be used to determine a relationship between a user and a user group.

In some examples, the user group identification instructions 122, when executed by processor 110, may authenticate the user. The user group identification instructions 122, when executed by processor 110, may authenticate the user based on the identified user group. For example, the user group identification instructions 122, when executed by processor 110, may authenticate the user based on a credential, certificate, and/or other type of authentication associated with the user group. The user may have rights, privileges, available functionality, and/or other access to the computing device 100 based on their association with the user group. For example, the user may have access to the computing device 100 that may be determined based on the access provided to the user group.

The network connection availability instructions 123, when executed by processor 110, may determine whether the user group associated with the user has control over any network connections available from the computing device. As mentioned above, the computing device 100 may comprise a set of network connections via which users of user groups may access the computing device 100, request and/or receive services via the computing device 100, and/or otherwise engage in communication with the computing device 100.

The network connection availability instructions 123, when executed by processor 110, may determine whether the user group has control over any network connections available from the computing device 100 based on data associated with each network connection. For example, the network connection availability instructions 123, when executed by processor 110, may determine whether the user group has access to a network connection and the ability to provide a next request to be performed via the network connection.

In some examples, the network connection availability instructions 123, when executed by processor 110, may poll each network connection to determine which user group has control of the network connection.

In some examples, a list of network connections and associated user groups may be stored in the non-transitory storage medium 120. The network connection availability instructions 123, when executed by processor 110, may access the list to determine whether the user group has control over any of the set of network connections. In these examples, the network connection availability instructions 123, when executed by processor 110, may also maintain the list, update the list when control of a network connection changes, and/or otherwise manage the list.

In some examples, the network connection availability instructions 123, when executed by processor 110, may determine whether a network connection is controlled by a user group based on whether a credential, certificate, and/or other type of authentication from the user group is associated with the network connection.

Responsive to the user group not having control over any network connections of the set of network connections of the computing device, the priority queue management instructions 124, when executed by processor 110, may include the request from the user of the user group in a priority queue for requests. Along with the request, in some examples, the priority queue management instructions 124, when executed by processor 110, may include information related to the user, the user group, a time/date at which the request was received, a number of network connections controlled by the user group, and/or other information related to the user, request, or user group.

The priority queue management instructions 124, when executed by processor 110, may place the request in sleep mode when including the request from the user in the priority queue. For example, the priority queue management instructions 124, when executed by processor 110, may comprise a thread-safe lock functionality that may place the request in sleep mode responsive to the request being included in the queue. The priority queue management instructions 124 (and/or the request selection instructions 125), when executed by processor 110, may cause the request to be woken up responsive to the request being selected to be performed.

In some examples, the priority queue management instructions 124, when executed by processor 110, may calculate a priority for the request. In some examples, the priority may comprise a numerical score, a ranking as compared to other requests in the queue, and/or other metric by which selection of a request from the queue may be determined.

The priority queue management instructions 124, when executed by processor 110, may calculate the priority responsive to the request entering the queue, may calculate and/or update the priority of each request in the queue at predetermined intervals, may calculate the priority responsive to another request leaving the queue, and/or may otherwise calculate the priority for a request. In some examples, the request selection instructions 125, as described below, when executed by processor 110, may calculate the priority for a request.

The priority queue management instructions 124, when executed by processor 110, may calculate a priority for the request based on a number of requests in the priority queue associated with the user group, based on a number of connections controlled by the user group, based on a number of requests received overall for the user group, based on a number of requests received overall for the user group as compared to other user groups, based on information related to the request, based on a size of the user group, based on a size of the user group relative to other user groups, based on a length of time the request has been in the queue, based on an application that may be used to perform the request, based on a type of service being requested in the request, and/or based on other factors.

In some examples, the priority queue management instructions 124, when executed by processor 110, may calculate a priority for a user group of the user from whom the request was received (instead of and/or in addition to calculating a priority for the request itself). The priority queue management instructions 124, when executed by processor 110, may calculate a priority for the user group in a manner the same as or similar to calculating a priority for the request.

The priority queue management instructions 124, when executed by processor 110, may calculate a priority for the user group based on a number of requests in the priority queue associated with the user group, based on a number of connections controlled by the user group, based on a number of requests received overall for the user group, based on a number of requests received overall for the user group as compared to other user groups, based on information related to the requests associated with the user group, based on a size of the user group, based on a size of the user group relative to other user groups, based on an average length of time that requests associated with the user group have been in the queue, based on applications that may be used to perform the requests associated with the user group, based on types of service being requested in the requests associated with the user group, and/or based on other factors.

Responsive to a network connection to the computing device becoming available, the request selection instructions 125, when executed by processor 110, may select the request based on a priority associated with the request. For example, a network connection to the computing device 100 may become available responsive to a request being completed on a network connection, a user group making available control of the network connection, and/or other ways by which a network connection may become available. In some examples, responsive to a request being completed on a network connection, the computing device 100 (and/or the network availability instructions 123, and/or other instructions) may facilitate the user group having control of the network connection releasing control of the network connection and causing an indication to be sent to the computing device 100 that the network connection is available.

In some examples, the request selection instructions 125, when executed by processor 110, may select the request based on the priority and/or based on an amount of time that the request has been in the priority queue. The request selection instructions 125, when executed by processor 110, may select a request with the highest priority, may select a request based on priority and amount of time that the request has been in the priority queue, and/or may select a request based on other factors.

In some examples, the request selection instructions 125, when executed by processor 110, may select a request based on a priority associated with the user group. For example, the request selection instructions 125, when executed by processor 110, may determine the user group from which a request may be selected responsive to priority being calculated for a user group.

Responsive to priority being calculated for user groups and for individual requests, the request selection instructions 125, when executed by processor 110, may select a request based on both priority for user group associated with the request and priority associated with the request itself. In some examples, the request selection instructions 125, when executed by processor 110, may weight each priority equally. In some examples, the request selection instructions 125, when executed by processor 110, may determine the user group from which the select the request based on the priority calculated for the user group and may determine a request associated the user group to select based on the individual priorities calculated for each request associated with the user group.

Responsive to priority being calculated for user groups (but not for individual requests, the request selection instructions 125, when executed by processor 110, may select a user group from which to select a request based on the priority calculated for user groups. For example, the request selection instructions 125, when executed by processor 110, may select the user group with the highest priority. The request selection instructions 125, when executed by processor 110, may then select a request associated with the user group based on wait time of the request, load balancing based on individual user who provided the request, application to be used to perform the request, type of service requested by the request, and/or based on other information related to the request.

The request selection instructions 125, when executed by processor 110, may also make available control of the available network connection to the user group associated with the user that provided the request, responsive to the network connection becoming available. For example, the request selection instructions 125, when executed by processor 110, may provide an indication to the user group that the network connection is available, may request authentication (e.g., a credential, certificate, and/or other type of authentication), from the user group, may provide access to the network connection to the user group, may change metadata associated with the network connection to indicate that the user group has access to the network connection, may update a list of network connections and associated user groups, and/or may otherwise make available control of the network connection to the user group.

In some examples, the request selection instructions 125, when executed by processor 110, may send an indication to the network connection availability instructions 123 to make a network connection available responsive to a predetermined amount of requests having been in the queue longer than a predetermined amount of time. In some examples, for a particular user group, a request may be automatically removed from the priority queue and cancelled responsive to a corresponding predetermined amount of time passing from the request being received.

The predetermined amount of requests and/or predetermined amount of time may be set by the system, by a system administrator, by one or more user groups, and/or in other ways. In some examples, a predetermined amount of time for requests of one user group may differ from a predetermined amount of time for another user group.

In some examples, the computing device 100 may require authentication of the user prior to making available control of the network connection to the user group. For example, the computing device 100 may authenticate the user based on authentication of the user group. The authentication of the user group may be performed, for example, responsive to making available control of the network connection to the user group, responsive to receiving the request, and/or at other times, as discussed above.

FIG. 2 is a block diagram of an example computing device 200 for multiplexing network connections. As with computing device 100, computing device 200 may be a cloud server, a mainframe, notebook, desktop, tablet, workstation, mobile device, or any other device suitable for executing the functionality described below. As with processor 110 of FIG. 1, processor 220 may be one or more CPUs, microprocessors, and/or other hardware devices suitable for retrieval and execution of instructions.

As detailed below, computing device 200 may include a series of engines 220-240 for multiplexing network connections. Each of the engines may generally represent any combination of hardware and programming. For example, the programming for the engines may be processor executable instructions stored on a non-transitory machine-readable storage medium and the hardware for the engines may include at least one processor of the computing device 200 to execute those instructions. In addition or as an alternative, each engine may include one or more hardware devices including electronic circuitry for implementing the functionality described below.

Request receipt engine 220 may determine that a request has been received from a user and determine a user group associated with the user. Request receipt engine 220 may authenticate the user based on a set of credentials associated with the user group. In some examples, the request receipt engine 220 may perform this functionality in a manner the same as or similar to that of the request receipt instructions 121, user group identification instructions 122, and/or other instructions of computing device 100. Further details regarding an example implementation of request receipt engine 220 are provided above in connection with request receipt instructions 121, user group identification instructions 122, and/or other instructions of FIG. 1.

Network connection availability engine 230 may determine whether a credential of the user group is associated with any network connections of the set of network connections. Network connection availability engine 230 may also determine whether a network connection of the set of network connections is available for the user group, responsive to determining that the credential of the user group is not associated with any network connections. Network connection availability engine 230 may perform the request via the associated network connection, responsive to a credential being associated with a first network connection. In some examples, the network connection availability engine 230 may perform this functionality in a manner the same as or similar to that of the network connection availability instructions 123 of computing device 100. Further details regarding an example implementation of network connection availability engine 230 are provided above in connection with network connection availability instructions 123 of FIG. 1.

Priority request management engine 240 may place the request in a priority queue responsive to determining that no network connections are available for the user group. The priority request management engine 240 may also select an individual request from a set of requests in the priority queue responsive to an individual network connection becoming available. For example, the priority request management engine 240 may select the individual request by determining a request priority for each request in the queue and selecting, as the individual request, a first request with the highest priority. In some examples, the priority request management engine 240 may perform this functionality in a manner the same as or similar to that of the computing device 100. Further details regarding an example implementation of priority request management engine 240 are provided above in connection with priority queue management instructions 124, request selection instructions 125, and/or other instructions of FIG. 1.

FIG. 3 is a block diagram of an example computing device for multiplexing network connections, where the computing device is in communication with user computing devices over a network. In the example depicted in FIG. 3, the computing device 200 may communicate with user computing devices 301, 302 of a first user group 300, user computing devices 311, 312 of a second user group, and user computing devices 321, 322 of an nth user group 320, where each user group and user computing device may be communicably coupled to the computing device 100 via a network 50. The network 50 may be any wired, wireless and/or other type of network via which the user groups and/or user computing devices may communicate with the computing device 100.

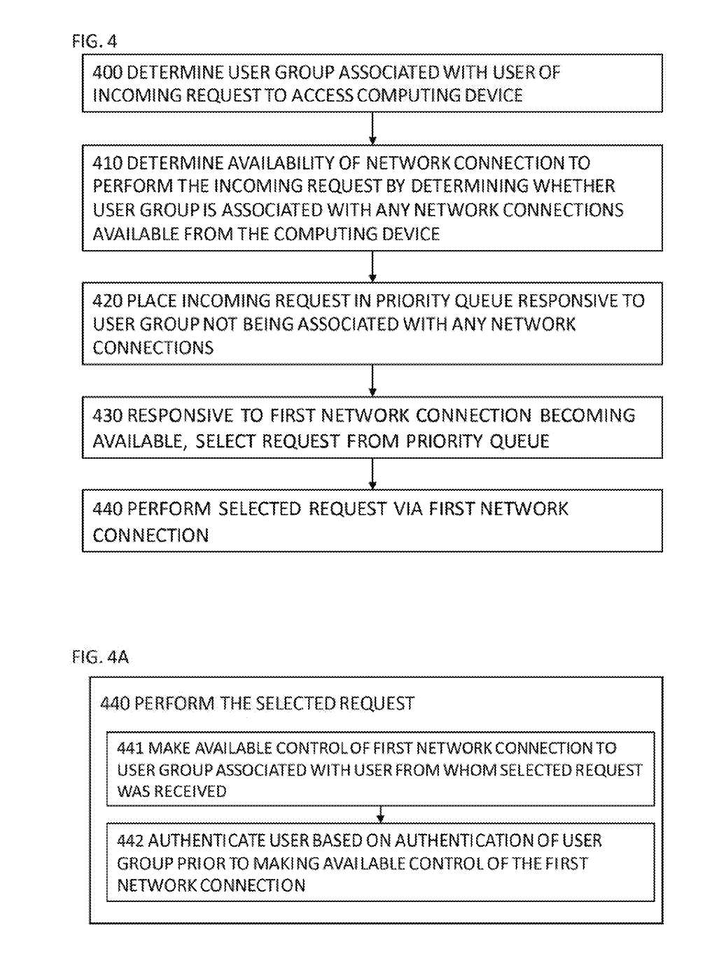

FIG. 4 is a flowchart of an example method for execution by a computing device for multiplexing network connections.

Although execution of the methods described below are with reference to computing device 100 of FIG. 1 and/or computing device 200 of FIGS. 2 and 3, other suitable devices for execution of this method will be apparent to those of skill in the art. The method described in FIG. 4 and other figures may be implemented in the form of executable instructions stored on a machine-readable storage medium, such as storage medium 120, by one or more engines described herein, and/or in the form of electronic circuitry.

In an operation 400, a user group associated with a user of an incoming request to access a computing device is determined. For example, the computing device 100 (and/or the request receipt instructions 121, the user group identification instructions 122, the request receipt engine 220, or other resource of the computing device 100) may determine the user group. The computing device 100 may determine the user group a manner similar or the same as that described above in relation to the execution of the request receipt instructions 121, the user group identification instructions 122, the request receipt engine 220, and/or other resource of the computing device 100.

In an operation 410, a determination may be made as to whether a network connection of a set of network connections available from the computing device is available to perform the incoming request. This determination may be made, for example, by determining whether the user group is associated with any of the set of network connections. For example, the computing device 100 (and/or the network connection availability instructions 123, network connection availability engine 240, or other resource of the computing device 100) may perform these determinations. The computing device 100 may perform these determinations in a manner similar or the same as that described above in relation to the execution of the network connection availability instructions 123, network connection availability engine 240, or other resource of the computing device 100.

In an operation 420, the incoming request may be placed in a priority queue responsive to the user group not being associated with any of the set of network connections. For example, the computing device 100 (and/or the priority queue management instructions 124, the priority request management engine 240, the priority queue management instructions 124, the priority request management engine 250, or other resource of the computing device 100) may place the incoming request in the priority queue. The computing device 100 may place the incoming request in the priority queue in a manner similar or the same as that described above in relation to the execution of the priority queue management instructions 124, the priority request management engine 240, or other resource of the computing device 100.

In an operation 430, a request may be selected from a set of requests of the priority queue, responsive to a network connection of the set of network connections becoming available. For example, the computing device 100 (and/or the priority queue management instructions 124, request selection instructions 125, the priority request management engine 240, or other resource of the computing device 100) may select the request. The computing device 100 may select the request in a manner similar or the same as that described above in relation to the execution of the priority queue management instructions 124, request selection instructions 125, the priority request management engine 240, and/or other resource of the computing device 100.

In an operation 440, the selected request may be performed via the network connection. For example, the computing device 100 (and/or the priority queue management instructions 124, request selection instructions 125, the priority request management engine 240, or other resource of the computing device 100) may perform the selected request. The computing device 100 may facilitate performance of the selected request in a manner similar or the same as that described above in relation to the execution of the priority queue management instructions 124, request selection instructions 125, the priority request management engine 240, and/or other resource of the computing device 100.

In some examples, the selected request may be performed in various manners. FIG. 4A is a flowchart of an example method for execution by a computing device for performing the selected request.

In an operation 441, control of the first network connection may be made available to the user group associated with the user from whom the selected request was received. For example, the computing device 100 (and/or the priority queue management instructions 124, request selection instructions 125, the priority request management engine 240, or other resource of the computing device 100) may make available the network connection. The computing device 100 may ass make available the network connection in a manner similar or the same as that described above in relation to the execution of the priority queue management instructions 124, request selection instructions 125, the priority request management engine 240, and/or other resource of the computing device 100.

In an operation 442, the user may be authenticated based on authentication of the user group prior to making, control of the network connection available to the user group. For example, the computing device 100 (and/or the priority queue management instructions 124, request selection instructions 125, the priority request management engine 240, or other resource of the computing device 100) may authenticate the user. The computing device 100 may authenticate the user in a manner similar or the same as that described above in relation to the execution of the priority queue management instructions 124, request selection instructions 125, the priority request management engine 240, and/or other resource of the computing device 100.

The foregoing disclosure describes a number of example embodiments for multiplexing network connections to use in communication with devices behind a firewall. The disclosed examples may include systems, devices, computer-readable storage media, and methods for multiplexing network connections. For purposes of explanation, certain examples are described with reference to the components illustrated in FIGS. 1-7. The functionality of the illustrated components may overlap, however, and may be present in a fewer or greater number of elements and components. Further, all or part of the functionality of illustrated elements may co-exist or be distributed among several geographically dispersed locations. Moreover, the disclosed examples may be implemented in various environments and are not limited to the illustrated examples.

Further, the sequence of operations described in connection with FIGS. 1-7 are examples and are not intended to be limiting. Additional or fewer operations or combinations of operations may be used or may vary without departing from the scope of the disclosed examples. Furthermore, implementations consistent with the disclosed examples need not perform the sequence of operations in any particular order. Thus, the present disclosure merely sets forth possible examples of implementations, and many variations and modifications may be made to the described examples. All such modifications and variations are intended to be included within the scope of this disclosure and protected by the following claims.

We claim:

1. A non-transitory machine-readable storage medium comprising instructions for multiplexing network connections, the instructions executable by a processor of a computing device to:
receive a first request from a first user to access the computing device;
identify a first user group with which the first user is associated;
determine whether the first user group has control over any network connections of a set of network connections available from the computing device;
responsive to the first user group not having control over any network connections of the set of network connections available from the computing device, include the first request in a priority queue for requests; and
responsive to a network connection to the computing device becoming available, select a request from the priority queue and make available control of the network connection to user group associated with a user from whom the request was received.

2. The storage medium of claim 1, further comprising instructions executable by the processor of the computing device to:
prior to making available control of the network connection to the user group, authenticate the user based on authentication of the user group.

3. The storage medium of claim 2, wherein the instructions executable by the processor of the computing device to select the request from the priority queue comprise instructions to:
select the request based on a priority associated with the request, wherein the priority for the request is calculated based on the user group associated with the request.

4. The storage medium of claim 3, further comprising instructions executable by the processor of the computing device to:
calculate the priority for the request based on a number of requests in the priority queue associated with the user group.

5. The storage medium of claim 3, further comprising instructions executable by the processor of the computing device to:
calculate the priority for the request based on a number of connections controlled by the user group.

6. The storage medium of claim 1, wherein the instructions executable by the processor of the computing device to determine whether the user group has control over any network connections comprise instructions to:
determine whether a network connection of the set of network connections that is being used for communication with the computing device is associated with a credential related to the user group.

7. The storage medium of claim 1, further comprising instructions executable by the processor of the computing device to,
make available a network connection that is being used for communication with the computing device responsive to a number of requests in the priority queue exceeding a predetermined threshold number.

8. A computing device for multiplexing network connections, the computing device comprising:
a request receipt engine to determine that a request has been received from a user and determine a user group associated with the user;
a network connection availability engine to:
determine whether a credential of the user group is associated with any network connections of a set of network connections; and
responsive to determining that the credential of the user group is not associated with any network connections, determine whether a network connection of the set of network connections is available for the user group; and
a priority queue management engine to:
place the request in a priority queue responsive to determining that no network connections are available for the user group; and
select an individual request from a set of requests in the priority queue responsive to an individual network connection becoming available.

9. The computing device of claim 8, wherein the network connection availability engine:
responsive to a credential being associated with a first network connection, performs the request via the associated network connection.

10. The computing device of claim 8, wherein the priority queue management engine selects the individual request by:
determining a request priority for each request in the queue; and
selecting, as the individual request, a first request with the highest priority.

11. The computing device of claim 8, wherein the request receipt engine:
authenticates the user based on a set of credentials associated with the user group.

12. A method for execution by a computing device for multiplexing network connections, the method comprising:
determining a user group associated with a user of an incoming request to access the computing device;
determining whether a network connection of a set of network connections available from the computing device is available to perform the incoming request by determining whether the user group is associated with any of the set of network connections;
placing the incoming request in a priority queue responsive to the user group not being associated with any of the set of network connections;
responsive to a first network connection of the set of network connections becoming available, selecting a request from a set of requests of the priority queue; and
performing the selected request via the first network connection.

13. The method of claim 12, wherein performing the selected request via the first network connection comprises:
making available control of the first network connection to an individual user group associated with an individual user from whom the selected request was received; and
prior to making available control, authenticating the individual user based on authentication of the individual user group.

14. The method of claim 13, further comprising:
receiving a list of users in the user group, the list of users including the user; and
receiving, for the user group, a set of credentials that provides authentication for each user in the user group.

15. The method of claim 13, wherein selecting the selected request comprises:
selecting the selected request based on a priority associated with the selected request, wherein the priority for the selected request is calculated based on the individual user group associated with the selected request.
